(19) United States
(12) Patent Application Publication
(10) Pub. No.: US 2011/0309316 A1
(43) Pub. Date: Dec. 22, 2011

(54) SEMI-SCISSOR LIFT

(75) Inventor: Jae-hoon Kim, Incheon (KR)

(73) Assignee: Heshbon Co., Ltd., Chungcheongnam-do (KR)

(21) Appl. No.: 13/127,758

(22) PCT Filed: Jun. 1, 2009
(86) PCT No.: PCT/KR2009/002906

§ 371 Date: May 5, 2011

(30) Foreign Application Priority Data
Mar. 13, 2009 (KR) 10-2009-0021802

(51) Int. Cl. B66F 7/16

(52) U.S. Cl. 254/89 H

(57) ABSTRACT

A semi-scissor lift includes a pair of vehicle loading plates parallel to one another, two pairs of lift units, each of which is configured to lift a corresponding vehicle loading plate, and a power unit configured to operate the two pairs of lift units. The power unit includes a number of hydraulic cylinder-piston assemblies, each having an end coupled to appropriate lift units. The number of hydraulic cylinder-piston assemblies includes a first hydraulic cylinder-piston assembly and a second hydraulic cylinder-piston assembly provided under different vehicle loading plates and at different sides thereof, and a third hydraulic cylinder-piston assembly provided under the same vehicle loading plate as the second hydraulic cylinder-piston assembly. Hydraulic cylinders associated with the first hydraulic cylinder-piston assembly and the second hydraulic cylinder-piston assembly and hydraulic cylinders associated with the second hydraulic cylinder-piston assembly and the third hydraulic cylinder-piston assembly are coupled in series to one another.

### CLAIM OF PRIORITY

This is a national phase application and claims priority from PCT Application Number PCT/KR/2009/002906 filed on Jun. 1, 2009, which claims priority to Korean Application No. 10-2009-0021802 filed on Mar. 13, 2009.

### FIELD OF TECHNOLOGY

This disclosure relates generally to vehicular lifting units and, more particularly, to a semi-scissor lift.

### BACKGROUND

A lifting unit for a vehicle (e.g., a car, a bus) may be adapted to enable lifting of a body of the vehicle from the ground surface such that one or more troubled elements of the body may be easily repaired. The lifting unit may be classified into post lifts and cross-link scissor lifts. In a cross-link lift (X-type or scissor lift), a pair of X-shaped cross-links may be installed on a pair of frames on either sides of a center thereof. Vehicle loading plates on which the vehicle is to be positioned may be installed to appropriate portions of the cross-links. Hydraulic cylinders may be mounted to lift and/or lower the X-shaped cross-links. Thus, the vehicle loading plates on which the vehicle is positioned may be lifted and/or lowered in accordance with the lifting and/or the lowering of the cross-links through the hydraulic cylinders.

As wheels of a vehicle are located outside the cross-links and vehicle loading plates are supported at appropriate points through portions of the cross-links, the vehicle loading plates inclined lengthwise when the weight of the vehicle is leaning to one side in the case of a scissor lift. When the vehicle is loaded on a lift, it is impossible to locate the gravity centers thereof at the center of the two (e.g., front and rear) support points of the cross-links. In the case of a scissor lift, if a vehicle is not located at the center of a width of the vehicle loading plates and is leaning to one side, a load of the vehicle may be concentrated to one cross-link, thereby transversely inclining the vehicle loading plates to one side. Such inclinations of the vehicle loading plates of the scissor lift may inconvenience a work requiring horizontal precision such as a wheel alignment (e.g., a wheel alignment may require a precision of 0.01 degrees).

In the case of the scissor lift, when a worker working under a vehicle loading plate is to laterally move to exchange a tool, for example, he/she may not help being caught by a cross-link or a hydraulic cylinder for lifting the cross-link. When the worker is to escape from the lift, he/she may need move to a front or rear side of the vehicle.

Compared to a scissor lift, a post lift (e.g., a four post lift) maybe advantageously prevent inclination of vehicle loading plates due to non-uniform distribution of the weight of the vehicle and may guarantee lateral mobility of the worker. However, in such a post lift, posts should be installed in a region wider than the width of the vehicle. Moreover, as front and rear posts should be located at an interval longer than the whole length of the vehicle, a space occupied by the lift may be large, thereby hampering efficient utilization of space within a maintenance shop.

### SUMMARY

A method, apparatus and/or a system of a semi-scissor lift are disclosed.

In one aspect, a semi-scissor lift includes a pair of vehicle loading plates parallel to one another, and two pairs of lift units, each of which is configured to lift a corresponding vehicle loading plate. The each lift unit is symmetrically provided with respect to a center of a length of the corresponding vehicle loading plate. The each lift unit includes a main link, an end of which is pivotally supported on a ground surface or a support plate and another end of which slidably supports the corresponding vehicle loading plate, and an auxiliary link having a length longer or shorter than the main link. One end of the auxiliary link is pivotably coupled to the corresponding vehicle loading plate and another end of the auxiliary link is pivotably coupled to the main link.

The semi-scissor lift also includes a power unit configured to operate the two pairs of lift units. The power unit includes a number of hydraulic cylinder-piston assemblies, each having an end coupled to a corresponding auxiliary link and another end supported through a corresponding main link. The vehicle loading plates are configured to be able to be lifted while the number of hydraulic cylinder-piston assemblies are extending. The number of hydraulic cylinder-piston assemblies includes a first hydraulic cylinder-piston assembly provided under the corresponding vehicle loading plate and a second hydraulic cylinder-piston assembly provided under a corresponding another vehicle loading plate. The second hydraulic cylinder-piston assembly is located on a side on the corresponding another vehicle loading plate further away from a side on the corresponding vehicle loading plate under which the first hydraulic cylinder-piston assembly is provided.

A second hydraulic cylinder associated with the second hydraulic cylinder-piston assembly is coupled in series with a first hydraulic cylinder associated with the first hydraulic cylinder-piston assembly through a first hydraulic line. The number of hydraulic cylinder-piston assemblies further includes a third hydraulic cylinder-piston assembly provided under the corresponding another vehicle loading plate where the second hydraulic cylinder-piston assembly is located. The third hydraulic cylinder-piston assembly is located on a side of the corresponding another vehicle loading plate further away from the second hydraulic cylinder-piston assembly. A third hydraulic cylinder associated with the third hydraulic cylinder-piston assembly is coupled in series with the second hydraulic cylinder of the second hydraulic cylinder-piston assembly through a second hydraulic line.

In another aspect, a method includes providing two pairs of lift units, each of which is configured to lift a corresponding vehicle loading plate, symmetrically with respect to a center of a length of the corresponding vehicle loading plate, and providing a power unit configured to operate the two pairs of lift units. The power unit includes a number of hydraulic cylinder-piston assemblies, each of which is coupled to the corresponding lift unit, and the number of hydraulic cylinder-piston assemblies includes a first hydraulic cylinder-piston assembly provided under the corresponding vehicle loading plate, and a second hydraulic cylinder-piston assembly provided under a corresponding another vehicle loading plate.

The second hydraulic cylinder-piston assembly is located on a side on the corresponding another vehicle loading plate further away from a side on the corresponding vehicle loading plate under which the first hydraulic cylinder-piston assembly is provided. A second hydraulic cylinder associated with the second hydraulic cylinder-piston assembly is coupled in series with a first hydraulic cylinder associated with the first hydraulic cylinder-piston assembly through a first hydraulic line. The number of hydraulic cylinder-piston assemblies also includes a third hydraulic cylinder-piston assembly provided under the corresponding another vehicle loading plate where the second hydraulic cylinder-piston assembly is located. The third hydraulic cylinder-piston assembly is located on a side of the corresponding another vehicle loading plate further away from the second hydraulic cylinder-piston assembly. A third hydraulic cylinder associated with the third hydraulic cylinder-piston assembly is coupled in series with the second hydraulic cylinder of the second hydraulic cylinder-piston assembly through a second hydraulic line.

The method also includes lifting the corresponding vehicle loading plate and the corresponding another vehicle loading plate through an extension of the plurality of hydraulic cylinder-piston assemblies.

In yet another aspect, a vehicular system includes a vehicle and a semi-scissor lift adapted to enable lifting of a body of the vehicle. The semi-scissor lift includes a pair of vehicle loading plates parallel to one another, and two pairs of lift units, with each of the lift units being configured to lift a corresponding vehicle loading plate. The each lift unit is symmetrically provided with respect to a center of a length of the corresponding vehicle loading plate. The each lift unit includes a main link, an end of which is pivotally supported on a ground surface or a support plate and another end of which slidably supports the corresponding vehicle loading plate, and an auxiliary link having a length longer or shorter than the main link.

One end of the auxiliary link is pivotably coupled to the corresponding vehicle loading plate and another end of the auxiliary link is pivotably coupled to the main link. The semi-scissor lift also includes a power unit configured to operate the two pairs of lift units. The power unit includes a number of hydraulic cylinder-piston assemblies, each having an end coupled to a corresponding auxiliary link and another end supported through a corresponding main link. The vehicle loading plates are configured to be able to be lifted while the number of hydraulic cylinder-piston assemblies are extending. The number of hydraulic cylinder-piston assemblies includes a first hydraulic cylinder-piston assembly provided under the corresponding vehicle loading plate, and a second hydraulic cylinder-piston assembly provided under a corresponding another vehicle loading plate. The second hydraulic cylinder-piston assembly is located on a side on the corresponding another vehicle loading plate further away from a side on the corresponding vehicle loading plate under which the first hydraulic cylinder-piston assembly is provided.

A second hydraulic cylinder associated with the second hydraulic cylinder-piston assembly is coupled in series with a first hydraulic cylinder associated with the first hydraulic cylinder-piston assembly through a first hydraulic line. The vehicular system also includes a third hydraulic cylinder-piston assembly provided under the corresponding another vehicle loading plate where the second hydraulic cylinder-piston assembly is located. The third hydraulic cylinder-piston assembly is located on a side of the corresponding another vehicle loading plate further away from the second hydraulic cylinder-piston assembly. A third hydraulic cylinder associated with the third hydraulic cylinder-piston assembly is coupled in series with the second hydraulic cylinder of the second hydraulic cylinder-piston assembly through a second hydraulic line.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a perspective view of a semi-scissor lift, according to one or more embodiments.

FIG. 2 is a schematic view of a power unit of the semi-scissor lift of FIG. 1, according to one or more embodiments.

FIG. 3 is a process flow diagram detailing the operations involved in a method of providing the semi-scissor lift of FIG. 1, according to one or more embodiments.

Other features of the present embodiments will be apparent from the accompanying drawings and from the detailed description that follows.

### DETAILED DESCRIPTION

A method, apparatus and/or system of a semi-scissor lift are disclosed. Although the present embodiments have been described with reference to specific example embodiments, it will be evident that various modifications and changes may be made to these embodiments without departing from the broader spirit and scope of the various embodiments.

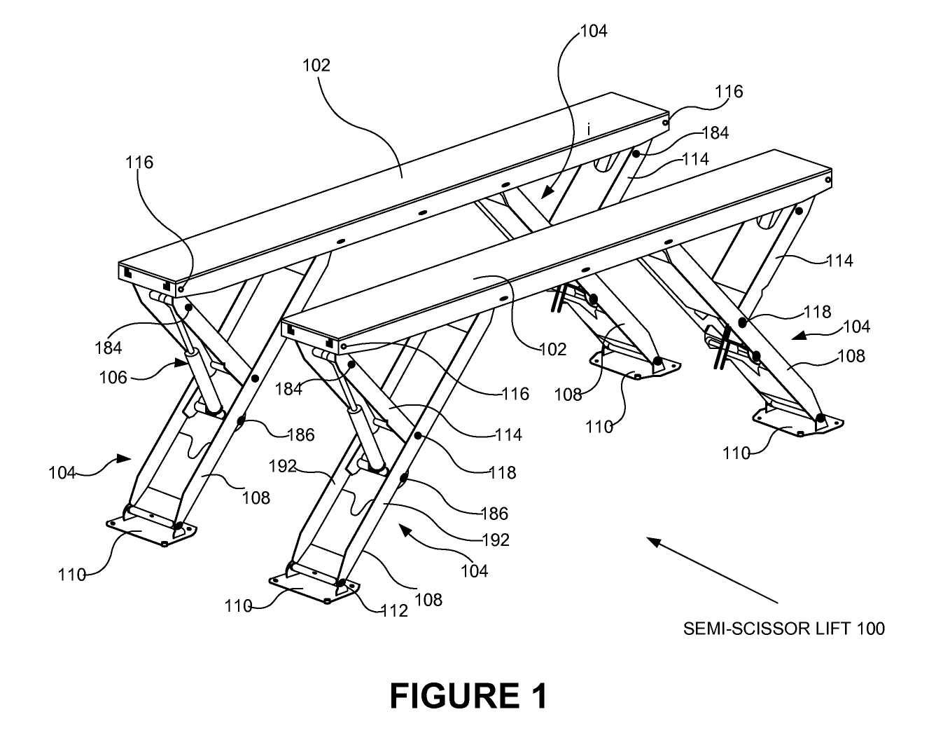

FIG. 1 shows a semi-scissor lift 100, according to one or more embodiments. In one or more embodiments, semi-scissor lift 100 may include a pair of vehicle loading plates 102 and two pairs of lift units 104, each pair being configured to lift a corresponding one of the pair of vehicle loading plates 102, as shown in FIG. 1. In one or more embodiments, each of the two pairs of lift units 104 may be symmetrically provided with respect to a center of a length (e.g., on either side of the center along the length) of the corresponding one of the pair of vehicle loading plates 102. In one or more embodiments, semi-scissor lift 100 may also include a power unit 106 configured to operate the two pairs of lift units 104. In one or more embodiments, each lift unit 104 may include a main link 108 pivotally supported on a ground surface or a support plate 110 (e.g., through a pin 112 coupling main link to support plate 110).

In one or more embodiments, an end of the main link 108 proximate a corresponding vehicle loading plate 102 may slidably support the corresponding vehicle loading plate 102, and an auxiliary link 114 preferably having a length shorter than main link 108 may be pivotably coupled to the corresponding vehicle loading plate 102 (e.g., through pin 116) at one end and to main link 108 (e.g., through pin 118).

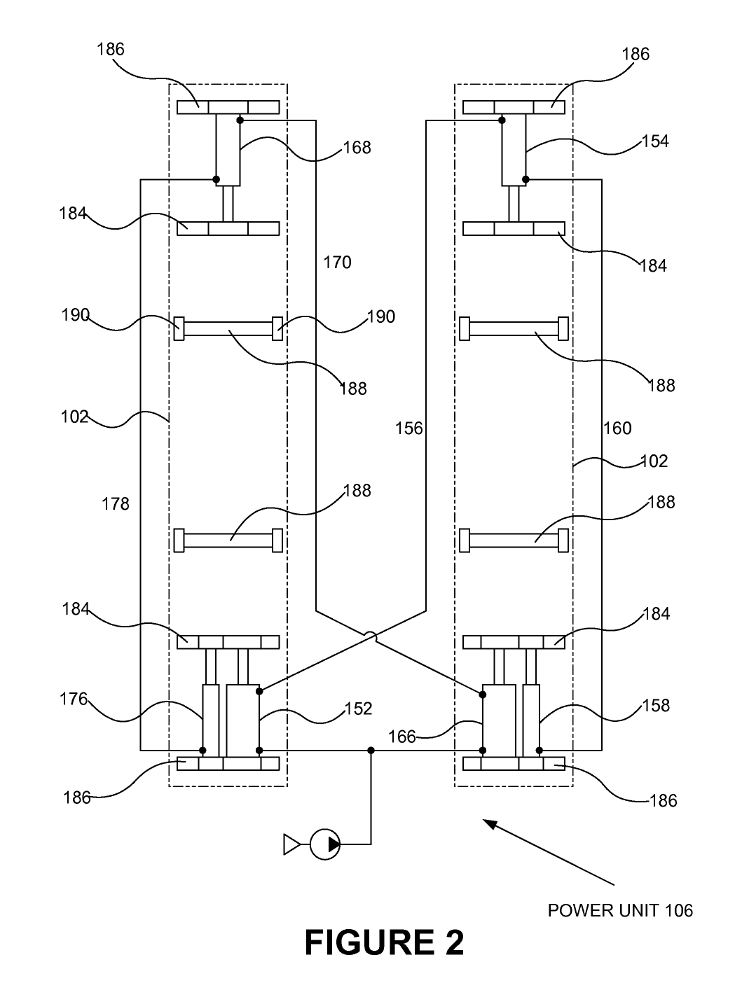

FIG. 2 shows power unit 106 of semi-scissor lift 100, according to one or more embodiments. In one or more embodiments, power unit 200 may include a number of hydraulic cylinder-piston assemblies, each of which has an end coupled to a corresponding auxiliary link 114 and another end supported through a corresponding main link 108 such that the pair of vehicle loading plates 102 may be lifted while the hydraulic cylinder-piston assemblies are extending.

In the example embodiments shown in FIG. 1 and FIG. 2, power unit 200 may include six hydraulic cylinder-piston assemblies. Here, a first hydraulic cylinder-piston assembly 152 may provided under a vehicle loading plate 102 and a second hydraulic cylinder-piston assembly 154 may be provided under the other vehicle loading plate 102. The second hydraulic cylinder-piston assembly 154 may be provided on a side on the corresponding vehicle loading plate 102 that is farther away from a side on the corresponding vehicle loading plate 102, at which the first hydraulic cylinder-piston assembly 152 is provided. The second hydraulic cylinder-piston assembly 154 may be coupled in series with the first hydraulic cylinder-piston assembly 152 through a hydraulic line 156. For example, hydraulic line 156 may couple an outlet of a hydraulic cylinder associated with the first hydraulic cylinder-piston assembly 152 to an inlet of a hydraulic cylinder associated with the second hydraulic cylinder-piston assembly 154.

A third hydraulic cylinder-piston assembly 158 may be provided under the vehicle loading plate 102 under which the second hydraulic cylinder-piston assembly 154 is also provided. It is obvious that the third hydraulic cylinder-piston assembly 158 may be provided in a side of the vehicle loading plate 102 farthest from the side of the vehicle under which the second hydraulic cylinder-piston assembly 154 is provided. The third hydraulic cylinder-piston assembly 158 may be coupled in series with the second hydraulic cylinder-piston assembly 154 through hydraulic line 160. For example, hydraulic line 160 may couple an outlet 162 of the hydraulic cylinder associated with the second hydraulic cylinder-piston assembly 154 to an inlet 164 of a hydraulic cylinder associated with the third hydraulic cylinder-piston assembly 158.

As shown in FIG. 2, a fourth hydraulic cylinder-piston assembly 166 may be provided parallel to and adjacent to the third hydraulic cylinder-piston assembly 158. A fifth hydraulic cylinder-piston assembly 168 may be provided under a corresponding vehicle loading plate 102 at which the first hydraulic cylinder-piston assembly 152 is provided. However, the fifth hydraulic cylinder-piston assembly 168 may be provided at a side farthest from the side of the vehicle loading plate 102 at which the first hydraulic cylinder-piston assembly 152 is provided.

The fifth hydraulic cylinder-piston assembly 168 may be coupled in series with the fourth hydraulic cylinder-piston assembly 166 through hydraulic line 170. Here, hydraulic line 170 may couple an outlet 172 of a hydraulic cylinder associated with the fourth hydraulic cylinder-piston assembly 166 to an inlet 174 of a hydraulic cylinder associated with the fifth hydraulic cylinder-piston assembly 168.

A sixth hydraulic cylinder-piston assembly 176 may be provided parallel to and adjacent to the first hydraulic cylinder-piston assembly 152. The sixth hydraulic cylinder-piston assembly 176 may be coupled in series with the fifth hydraulic cylinder-piston assembly 168 through a hydraulic line 178. Here, hydraulic line 178 may couple an outlet 180 of a hydraulic cylinder associated with the fifth hydraulic cylinder-piston assembly 168 to an inlet 182 of a hydraulic cylinder associated with the sixth hydraulic cylinder-piston assembly 176.

In one or more embodiments, a cross-sectional area of an internal cavity of the hydraulic cylinder associated with the first hydraulic cylinder-piston assembly 152 (excluding the area occupied by the piston rod) may be the same as a cross-sectional area of an internal cavity of the hydraulic cylinder associated with the second hydraulic cylinder-piston assembly 154. The cross-sectional area of the internal cavity of the second hydraulic cylinder-piston assembly 154 (excluding the area occupied by the piston rod) may be the same as a cross-sectional area of an internal cavity of the hydraulic cylinder associated with the third hydraulic cylinder-piston assembly 158 (excluding the area occupied by the piston rod). Thus, in one or more embodiments, an operation of the piston rod of the hydraulic cylinder associated with the first hydraulic cylinder-piston assembly 152, an operation of the piston rod of the hydraulic cylinder associated with the second hydraulic cylinder-piston assembly 154 and an operation of the piston rod of the hydraulic cylinder associated with the third hydraulic cylinder-piston assembly 158 may be synchronized.

In one or more embodiments, a cross-sectional area of an internal cavity of the hydraulic cylinder associated with the fourth hydraulic cylinder-piston assembly 166 (excluding the area occupied by the piston rod) may be the same as a cross-sectional area of an internal cavity of the hydraulic cylinder associated with the fifth hydraulic cylinder-piston assembly 168, and a cross-sectional area of the internal cavity of the hydraulic cylinder associated with the fifth hydraulic cylinder-piston assembly 168 may be the same as a cross-sectional area of an internal cavity of the hydraulic cylinder associated with the sixth hydraulic cylinder-piston assembly 176.

In one or more embodiments, an end of the piston rod of the first hydraulic cylinder-piston assembly 152 and an end of the piston rod of the third hydraulic cylinder-piston assembly 158 may be arranged on a same line and coupled to a same pin 184 to be synchronized, and an end of the piston rod of the fourth hydraulic cylinder-piston assembly 166 and an end of the piston rod of the third hydraulic cylinder-piston assembly 158 may be arranged on a same line and coupled to a same pin 184 to be synchronized such that the lift units 104 located at different vehicle loading plates 102 are synchronized to one another and the lift units 104 at either side of the center of each of the vehicle loading plates 102 are also synchronized with each other.

In a preferred embodiment, the piston rods of all six hydraulic cylinder-piston assemblies may be coupled to corresponding auxiliary link(s) 114 through pins 184 and hydraulic cylinders of all six hydraulic cylinder-piston assemblies may be supported through main links 108 using pins 186. In one or more embodiments, as discussed above, an end of each main link 108 may be supported through a ground surface or support plate 110 (e.g., through pin 116). In one or more embodiments, another end of each main link 108 may slidably support vehicle loading plate 102 through an operation link 188 (see FIG. 2). In an example embodiment, hexahedral guide members 190 (again, see FIG. 2), or, rollers, configured to support the sliding movement of operation link 188, may be provided at opposite ends of operation link 188 such that guide members 190 move along guide grooves provided at appropriate portions of vehicle loading plate 102.

In another example embodiment, roller-type guide members 190 may be utilized to reduce a frictional force generated due to the sliding movement with respect to vehicle loading plate 102 discussed above. In one or more embodiments, main link 108 may include two long frames 192 and/or a transverse frame configured to couple and reinforce the long frames 192. In one or more embodiments, as discussed above and shown in FIGS. 1 and 2, auxiliary link 114 may have a length shorter than that of main link 108. In one or more embodiments, an end of auxiliary link 114 may be coupled to pin 116 provided at an appropriate side of vehicle loading plate 102 and another end thereof may be coupled to main link 108 through pin 118. In one or more embodiments, the another end of auxiliary link 114 may be supported through pin 118 at a substantially intermediate portion of main link 108. In one or more embodiments, pin 116 may not be slid with respect to vehicle loading plate 102 and may remain fixed thereto.

As shown in FIG. 1, in one or more embodiments, main link 108 and auxiliary link 114 may be coupled to each other in a “Y”-like shape (or, a mirror “Y”-like shape). Although main link 108 is shown as having a width larger than the auxiliary link 114 such that an end of auxiliary link 114 is configured to be received within main link 108 (as shown in FIG. 1), it is obvious that auxiliary link 114 may instead have a width larger than main link 108 such that main link 108 is configured to be received within auxiliary link 114. In both scenarios, it is obvious that pin 118 may be utilized to couple auxiliary link 114 and main link 108.

Also, it is obvious that semi-scissor lift 100 may enable lifting of a body of a vehicle. A vehicular system including semi-scissor lift 100 may include semi-scissor lift 100 and a vehicle (e.g., a car).

In one or more embodiments, exemplary embodiments may provide for a semi-scissor lift (e.g., semi-scissor lift 100) that combines the advantages of a scissor lift and a four-post lift by avoiding problems associated with declination of the scissor lift due to a non-uniformly distributed weight, inefficient space utilization of the four-post lift and inconvenient lateral movement of the scissor lift. In one or more embodiments, semi-scissor lift 100 may support one vehicle loading plate 102 at four outer points when compared to a traditional scissor lift adapted to support one vehicle loading plate at two middle points (lest the vehicle loading plate should be inclined as in a four-post lift) even when the weight of a vehicle is non-uniformly distributed, making it possible to perform work requiring precision such as a wheel alignment.

In one or more embodiments, semi-scissor lift 100 may occupy the same space as a conventional scissor lift, thereby allowing for efficiency in space utilization. In one or more embodiments, semi-scissor lift 100 may moves a lift unit 104 to an outside thereof as compared to a conventional scissor lift, thereby allowing for an easy lateral movement of a worker utilizing semi-scissor lift 100. The ease in lateral movement of the worker may provide for improved work efficiency.

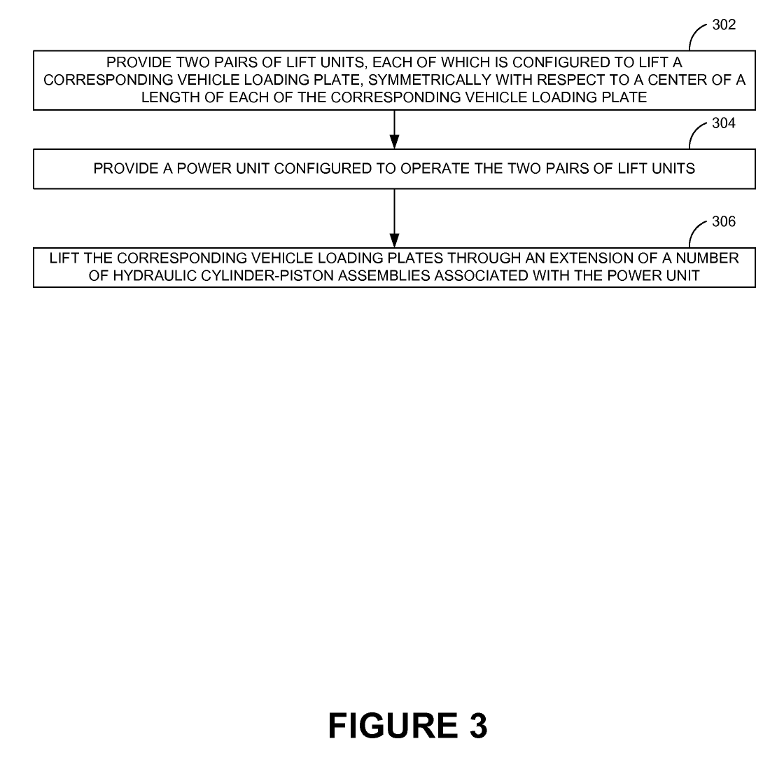

FIG. 3 shows a process flow diagram detailing the operations involved in a method of providing a semi-scissor lift 100 that advantageously provides for better space utilization and improved work efficiency, according to one or more embodiments. In one or more embodiments, operation 302 may include providing two pairs of lift units 104, each of which is configured to lift a corresponding vehicle loading plate 102, symmetrically with respect to a center of a length of the corresponding vehicle loading plate 102.

In one or more embodiments, operation 304 may include providing a power unit 106 configured to operate the two pairs of lift units 104. In one or more embodiments, power unit 106 may include a number of hydraulic cylinder-piston assemblies, each of which is coupled to the corresponding lift unit 104. In one or more embodiments, the number of hydraulic cylinder-piston assemblies may include a first hydraulic cylinder-piston assembly 152 provided under the corresponding vehicle loading plate 102 and a second hydraulic cylinder-piston assembly 154 provided under a corresponding another vehicle loading plate 102. In one or more embodiments, second hydraulic cylinder-piston assembly 154 may be located on a side on the corresponding another vehicle loading plate 102 further away from a side on the corresponding vehicle loading plate 102 under which first hydraulic cylinder-piston assembly 152 is provided.

In one or more embodiments, a second hydraulic cylinder associated with second hydraulic cylinder-piston assembly 154 may be coupled in series with a first hydraulic cylinder associated with first hydraulic cylinder-piston assembly 152 through a first hydraulic line (e.g., hydraulic line 156). In one or more embodiments, the number of hydraulic cylinder-piston assemblies may include a third hydraulic cylinder-piston assembly 158 provided under the corresponding another vehicle loading plate 102 where second hydraulic cylinder-piston assembly 154 is located. In one or more embodiments, third hydraulic cylinder-piston assembly 158 may be located on a side of the corresponding another vehicle loading plate 102 further away from second hydraulic cylinder-piston assembly 154. In one or more embodiments, third hydraulic cylinder associated with third hydraulic cylinder-piston assembly 158 may be coupled in series with the second hydraulic cylinder of second hydraulic cylinder-piston assembly 154 through a second hydraulic line (e.g., hydraulic line 160).

In one or more embodiments, operation 306 may then involve lifting the corresponding vehicle loading plate 102 and the corresponding another vehicle loading plate 102 through an extension of the number of hydraulic cylinder-piston assemblies.

Although the present embodiments have been described with reference to specific example embodiments, it will be evident that various modifications and changes may be made to these embodiments without departing from the broader spirit and scope of the various embodiments.

In addition, it will be appreciated that the various operations, processes, and methods disclosed herein may be performed in any order (e.g., including using means for achieving the various operations). Accordingly, the specification and drawings are to be regarded in an illustrative rather than a restrictive sense.

What is claimed is:

1. A semi-scissor lift comprising:
a pair of vehicle loading plates parallel to one another;
two pairs of lift units, each of which is configured to lift a corresponding vehicle loading plate, the each lift unit being symmetrically provided with respect to a center of a length of the corresponding vehicle loading plate, and the each lift unit including:
a main link, an end of which is pivotally supported on one of a ground surface and a support plate and another end of which slidably supports the corresponding vehicle loading plate; and
an auxiliary link having a length one of longer and shorter than the main link, one end of the auxiliary link being pivotably coupled to the corresponding vehicle loading plate and another end of the auxiliary link being pivotably coupled to the main link; and
a power unit configured to operate the two pairs of lift units, the power unit including a plurality of hydraulic cylinder-piston assemblies, each having an end coupled to a corresponding auxiliary link and another end supported through a corresponding main link, the vehicle loading plates being configured to be able to be lifted while the plurality of hydraulic cylinder-piston assemblies are extending, and the plurality of hydraulic cylinder-piston assemblies including:
a first hydraulic cylinder-piston assembly provided under the corresponding vehicle loading plate;
a second hydraulic cylinder-piston assembly provided under a corresponding another vehicle loading plate, the second hydraulic cylinder-piston assembly being located on a side on the corresponding another vehicle loading plate further away from a side on the corresponding vehicle loading plate under which the first hydraulic cylinder-piston assembly is provided, and a second hydraulic cylinder associated with the second hydraulic cylinder-piston assembly being coupled in series with a first hydraulic cylinder associated with the first hydraulic cylinder-piston assembly through a first hydraulic line; and
a third hydraulic cylinder-piston assembly provided under the corresponding another vehicle loading plate where the second hydraulic cylinder-piston assembly is located, the third hydraulic cylinder-piston assembly being located on a side of the corresponding another vehicle loading plate further away from the second hydraulic cylinder-piston assembly, a third hydraulic cylinder associated with the third hydraulic cylinder-piston assembly being coupled in series with the second hydraulic cylinder of the second hydraulic cylinder-piston assembly through a second hydraulic line.

2. The semi-scissor lift of claim 1, wherein the plurality of hydraulic cylinder-piston assemblies further comprises:
a fourth hydraulic cylinder-piston assembly provided parallel to and adjacent to the third hydraulic cylinder-piston assembly;
a fifth hydraulic cylinder-piston assembly provided under the corresponding vehicle loading plate and located on a side further away from the fourth hydraulic cylinder-piston assembly, a fifth hydraulic cylinder associated with the fifth hydraulic cylinder-piston assembly being coupled in series with a fourth hydraulic cylinder associated with the fourth hydraulic cylinder-piston assembly through a third hydraulic line; and
a sixth hydraulic cylinder-piston assembly provided parallel to and adjacent to the first hydraulic cylinder-piston assembly, a sixth hydraulic cylinder associated with the sixth hydraulic cylinder-piston assembly being coupled in series with the fifth hydraulic cylinder through a fourth hydraulic line.

3. The semi-scissor lift of claim 2,
wherein a cross-sectional area of an internal cavity of the first hydraulic cylinder excluding an area occupied by a first piston rod is substantially the same as a cross-sectional area of an internal cavity of the second hydraulic cylinder,
wherein a cross-sectional area of the internal cavity of the second hydraulic cylinder excluding an area occupied by a second piston rod is substantially the same as a cross-sectional area of an internal cavity of the third hydraulic cylinder excluding an area occupied by a third piston rod, and
wherein the similarity of cross-sectional areas provide for an operation of the first piston rod, the second piston rod and the third piston rod to be synchronized.

4. The semi-scissor lift of claim 3, wherein a cross-sectional area of an internal cavity of the fourth hydraulic cylinder excluding an area occupied by a fourth piston rod is substantially the same as a cross-sectional area of an internal cavity of the fifth hydraulic cylinder, and a cross-sectional area of the internal cavity of the fifth hydraulic cylinder excluding an area occupied by the fifth piston rod is substantially the same as a cross-sectional area of an internal cavity of the sixth hydraulic cylinder excluding an area occupied by the sixth piston rod.

5. The semi-scissor lift of claim 4, wherein an end of the first piston rod and an end of the third piston rod are arranged on a same line and coupled to a same pin to be synchronized, and an end of the fourth piston rod and an end of the third piston rod are arranged on a same line and coupled to the same pin to be synchronized such that the lift units located at both the same and different vehicle loading plates are synchronized with each other.

6. The semi-scissor lift of claim 4, wherein one end of each of the first piston rod, the second piston rod, the third piston rod, the fourth piston rod, the fifth piston rod and the sixth piston rod is coupled to the corresponding auxiliary link through pins analogous to the same pin and one end of each of the first hydraulic cylinder, the second hydraulic cylinder, the third hydraulic cylinder, the fourth hydraulic cylinder, the fifth hydraulic cylinder and the sixth hydraulic cylinder is supported through the corresponding main link through an appropriate pin.

7. The semi-scissor lift of claim 1, wherein the another end of the main link slidably supports the corresponding vehicle loading plate through an operation link having rollers configured to support a sliding movement thereof, the rollers being provided at opposite ends of the operation link such that the rollers are configured to move along guide grooves provided at appropriate portions of the corresponding vehicle loading plate.

8. The semi-scissor lift of claim 1, wherein the main link includes two long frames and a transverse frame configured to couple and to reinforce the long frames.

9. The semi-scissor lift of claim 1, wherein the main link and the auxiliary link are coupled to each other in one of a “Y”-like shape and a minor “Y”-like shape.

10. The semi-scissor lift of claim 1,
wherein the main link is pivotally supported on the one of the ground surface and the support plate through an appropriate pin,
wherein the one end of the auxiliary link is coupled to the corresponding vehicle loading plate through another appropriate pin provided thereat, and
wherein the another end of the auxiliary link is pivotably coupled to the main link also through a pin.

11. The semi-scissor lift of claim 2,
wherein the third hydraulic line couples an outlet of the fourth hydraulic cylinder to an inlet of the fifth hydraulic cylinder,
wherein the fourth hydraulic line couples an outlet of the fifth hydraulic cylinder to an inlet of the sixth hydraulic cylinder,
wherein the first hydraulic line couples an outlet of the first hydraulic cylinder to an inlet of the second hydraulic cylinder, and
wherein the second hydraulic line couples an outlet of the second hydraulic cylinder to an inlet of the third hydraulic cylinder.

12. A method comprising:
providing two pairs of lift units, each of which is configured to lift a corresponding vehicle loading plate, symmetrically with respect to a center of a length of each of the corresponding vehicle loading plate;
providing a power unit configured to operate the two pairs of lift units, the power unit comprising a plurality of hydraulic cylinder-piston assemblies, each of which is coupled to the corresponding lift unit, and the plurality of hydraulic cylinder-piston assemblies including:
a first hydraulic cylinder-piston assembly provided under the corresponding vehicle loading plate;
a second hydraulic cylinder-piston assembly provided under a corresponding another vehicle loading plate, the second hydraulic cylinder-piston assembly being located on a side on the corresponding another vehicle loading plate further away from a side on the corresponding vehicle loading plate under which the first hydraulic cylinder-piston assembly is provided, and a second hydraulic cylinder associated with the second hydraulic cylinder-piston assembly being coupled in series with a first hydraulic cylinder associated with the first hydraulic cylinder-piston assembly through a first hydraulic line; and
a third hydraulic cylinder-piston assembly provided under the corresponding another vehicle loading plate where the second hydraulic cylinder-piston assembly is located, the third hydraulic cylinder-piston assembly being located on a side of the corresponding another vehicle loading plate further away from the second hydraulic cylinder-piston assembly, a third hydraulic cylinder associated with the third hydraulic cylinder-piston assembly being coupled in series with the second hydraulic cylinder of the second hydraulic cylinder-piston assembly through a second hydraulic line; and
lifting the corresponding vehicle loading plate and the corresponding another vehicle loading plate through an extension of the plurality of hydraulic cylinder-piston assemblies.

13. The method of claim 12, wherein each of the lift unit includes:
a main link, an end of which is pivotally supported on one of a ground surface and a support plate and another end of which slidably supports the corresponding vehicle loading plate; and
an auxiliary link having a length one of longer and shorter than the main link, one end of the auxiliary link being pivotably coupled to the corresponding vehicle loading plate and another end of the auxiliary link being pivotably coupled to the main link.

14. The method of claim 12, wherein the plurality of hydraulic cylinder-piston assemblies further comprises:
a fourth hydraulic cylinder-piston assembly provided parallel to and adjacent to the third hydraulic cylinder-piston assembly;
a fifth hydraulic cylinder-piston assembly provided under the corresponding vehicle loading plate and located on a side further away from the fourth hydraulic cylinder-piston assembly, a fifth hydraulic cylinder associated with the fifth hydraulic cylinder-piston assembly being coupled in series with a fourth hydraulic cylinder associated with the fourth hydraulic cylinder-piston assembly through a third hydraulic line; and
a sixth hydraulic cylinder-piston assembly provided parallel to and adjacent to the first hydraulic cylinder-piston assembly, a sixth hydraulic cylinder associated with the sixth hydraulic cylinder-piston assembly being coupled in series with the fifth hydraulic cylinder through a fourth hydraulic line.

15. The method of claim 14, further comprising:
providing the first hydraulic cylinder-piston assembly and the second hydraulic cylinder-piston assembly such that a cross-sectional area of an internal cavity of the first hydraulic cylinder excluding an area occupied by a first piston rod is substantially the same as a cross-sectional area of an internal cavity of the second hydraulic cylinder;
providing the third hydraulic cylinder-piston assembly such that a cross-sectional area of the internal cavity of the second hydraulic cylinder excluding an area occupied by a second piston rod is substantially the same as a cross-sectional area of an internal cavity of the third hydraulic cylinder excluding an area occupied by a third piston rod; and
synchronizing an operation of the first piston rod, the second piston rod and the third piston rod through the similarity of cross-sectional areas associated with the corresponding hydraulic cylinder-piston assemblies.

16. The method of claim 15, further comprising:
providing the fourth hydraulic cylinder-piston assembly, the fifth hydraulic cylinder-piston assembly and the sixth hydraulic cylinder-piston assembly such that a cross-sectional area of an internal cavity of the fourth hydraulic cylinder excluding an area occupied by a fourth piston rod is substantially the same as a cross-sectional area of an internal cavity of the fifth hydraulic cylinder, and a cross-sectional area of the internal cavity of the fifth hydraulic cylinder excluding an area occupied by the fifth piston rod is substantially the same as a cross-sectional area of an internal cavity of the sixth hydraulic cylinder excluding an area occupied by the sixth piston rod.

17. The method of claim 16, comprising:
arranging an end of each of the first piston rod and the third piston rod on a same line and coupling the end thereof to a same pin; and
arranging an end of each of the fourth piston rod and the third piston rod on a same line and coupled the end thereof also to the same pin
to enable the lift units located at both the same and different vehicle loading plates to be synchronized.

18. A vehicular system comprising:
a vehicle; and
a semi-scissor lift adapted to enable lifting of a body of the vehicle, the semi-scissor lift comprising:
a pair of vehicle loading plates parallel to one another;
two pairs of lift units, each of the lift units being configured to lift a corresponding vehicle loading plate, the each lift unit being symmetrically provided with respect to a center of a length of the corresponding vehicle loading plate, and the each lift unit including:
a main link, an end of which is pivotally supported on one of a ground surface and a support plate and another end of which slidably supports the corresponding vehicle loading plate; and
an auxiliary link having a length one of longer and shorter than the main link, one end of the auxiliary link being pivotably coupled to the corresponding vehicle loading plate and another end of the auxiliary link being pivotably coupled to the main link; and
a power unit configured to operate the two pairs of lift units, the power unit including a plurality of hydraulic cylinder-piston assemblies, each having an end coupled to a corresponding auxiliary link and another end supported through a corresponding main link, the vehicle loading plates being configured to be able to be lifted while the plurality of hydraulic cylinder-piston assemblies are extending, and the plurality of hydraulic cylinder-piston assemblies including:
a first hydraulic cylinder-piston assembly provided under the corresponding vehicle loading plate;
a second hydraulic cylinder-piston assembly provided under a corresponding another vehicle loading plate, the second hydraulic cylinder-piston assembly being located on a side on the corresponding another vehicle loading plate further away from a side on the corresponding vehicle loading plate under which the first hydraulic cylinder-piston assembly is provided, and a second hydraulic cylinder associated with the second hydraulic cylinder-piston assembly being coupled in series with a first hydraulic cylinder associated with the first hydraulic cylinder-piston assembly through a first hydraulic line; and
a third hydraulic cylinder-piston assembly provided under the corresponding another vehicle loading plate where the second hydraulic cylinder-piston assembly is located, the third hydraulic cylinder-piston assembly being located on a side of the corresponding another vehicle loading plate further away from the second hydraulic cylinder-piston assembly, a third hydraulic cylinder associated with the third hydraulic cylinder-piston assembly being coupled in series with the second hydraulic cylinder of the second hydraulic cylinder-piston assembly through a second hydraulic line.

19. The vehicular system of claim 18, wherein the plurality of hydraulic cylinder-piston assemblies further comprises:
a fourth hydraulic cylinder-piston assembly provided parallel to and adjacent to the third hydraulic cylinder-piston assembly;
a fifth hydraulic cylinder-piston assembly provided under the corresponding vehicle loading plate and located on a side further away from the fourth hydraulic cylinder-piston assembly, a fifth hydraulic cylinder associated with the fifth hydraulic cylinder-piston assembly being coupled in series with a fourth hydraulic cylinder associated with the fourth hydraulic cylinder-piston assembly through a third hydraulic line; and
a sixth hydraulic cylinder-piston assembly provided parallel to and adjacent to the first hydraulic cylinder-piston assembly, a sixth hydraulic cylinder associated with the sixth hydraulic cylinder-piston assembly being coupled in series with the fifth hydraulic cylinder through a fourth hydraulic line.

20. The vehicular system of claim 19,
wherein a cross-sectional area of an internal cavity of the first hydraulic cylinder excluding an area occupied by a first piston rod is substantially the same as a cross-sectional area of an internal cavity of the second hydraulic cylinder,
wherein a cross-sectional area of the internal cavity of the second hydraulic cylinder excluding an area occupied by a second piston rod is substantially the same as a cross-sectional area of an internal cavity of the third hydraulic cylinder excluding an area occupied by a third piston rod, and
wherein the similarity of cross-sectional areas provide for an operation of the first piston rod, the second piston rod and the third piston rod to be synchronized.
